(19) United States
(12) Patent Application Publication
(10) Pub. No.: US 2011/0313614 A1
(43) Pub. Date: Dec. 22, 2011

(54) INTEGRATED AEROELASTICITY MEASUREMENT FOR VEHICLE HEALTH MANAGEMENT

(76) Inventors: Harris O. Hinnant, JR., Seattle, WA (US); David J. Black, Renton, WA (US); Darin W. Brekke, Fox Island, WA (US); Mark A. Castelluccio, Maple Valley, WA (US)

(21) Appl. No.: 12/820,119

(22) Filed: Jun. 21, 2010

(51) Int. Cl. G06F 7/00

(52) U.S. Cl. 701/33; 701/35

(57) ABSTRACT

Systems and methods for aeroelasticity measurement and vehicle structural health analysis and monitoring are disclosed. In one embodiment, a computer based system to monitor structural integrity of an aircraft comprises a processor and a memory module coupled to the processor and comprising logic instructions stored on a computer readable medium which, when executed by the processor, configures the processor to receive a plurality of aeroelasticity measurements and associated flight parameters collected in real time during a flight operation, store the plurality of aeroelasticity measurements and associated flight parameters in a persistent storage medium, and generate an alert when one or more aeroelasticity parameters exceeds a threshold. In some embodiments, the system may be implemented in a computing system or as logic instructions recorded on a computer readable medium.

### BACKGROUND

The subject matter described herein relates to monitoring and reporting of vehicle structural integrity data. Aircraft may include one or more monitoring systems that record data regarding various aspects of vehicle operation and performance that occur during the operation of the vehicle. For example, integrated systems for measuring wing twist have been developed for flight test purposes and are referred to herein as integrated aeroelasticity measurement systems. Current practice employs the integrated aeroelasticity measurement system in flight testing, using it to measure actual twist and bending of the airframe for selected flight conditions (aircraft speed, altitude, and fuel load and the like) and measurement points on the wing or body. The data may be used to remove uncertainty in the lift/drag ratio computation, leading to an improved wing design and better understanding of actual performance (meaning more confidence in performance guarantees to the customer). After the flight test data is generated, the integrated aeroelasticity measurement system is removed from the aircraft.

Real-time aeroelasticity data has not been available in commercial aircraft, except in limited flight test situations. Rather, determining aeroelasticity data for commercial aircraft has involved observing fuel efficiency and working backward to deduce the wing twist parameters. Vehicle designs and components change regularly, as do monitoring and maintenance needs for various vehicle systems. Accordingly, systems and methods for aircraft monitoring and reporting which allow enhanced abilities to evaluate conditions, including aeroelasticity conditions, may find utility.

### SUMMARY

Embodiments of systems and methods in accordance with the present disclosure may provide and disclose methods for an aircraft subsystem that incorporates real time aeroelasticity measurement together with avionics data (e.g., navigation state, weight, etc.) to perform condition identification and assessment consistent with vehicle structural health analysis and monitoring that is both real time in-flight and long term ground based. In one embodiment, a computer based system to monitor structural integrity of an aircraft comprises a processor and a memory module coupled to the processor and comprising logic instructions stored on a computer readable medium which, when executed by the processor, configures the processor to receive a plurality of aeroelasticity measurements and associated flight parameters collected in real time during a flight operation, assess the plurality of aeroelasticity measurements and associated flight parameters to identify conditions of interest then stored in a persistent storage medium, and generate an alert when one or more conditions exceeds a threshold. In some embodiments, the system may be implemented in a computing system or as logic instructions recorded on a computer readable medium.

In another embodiment, a method to monitor structural integrity of an aircraft comprises receiving, in a processing device aboard the aircraft, a plurality of aeroelasticity measurements and associated flight parameters collected in real time during a flight operation, storing the plurality of aeroelasticity measurements and associated flight parameters in a persistent storage medium, and generating an alert when one or more aeroelasticity parameters exceeds a threshold.

In a further embodiment, A system to monitor structural health of an aircraft, the system comprising a first computer program product to implement a real-time vehicle structural health monitoring process in an aircraft, the computer program product comprising logic instructions stored on a computer readable medium which, when executed by a processor, configure the processor to receive a plurality of aeroelasticity measurements and associated flight parameters collected in real time during a flight operation of the aircraft, store the plurality of aeroelasticity measurements and associated flight parameters in a persistent storage medium, and generate an alert when one or more aeroelasticity parameters exceeds a threshold.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

Embodiments of methods and systems in accordance with the teachings of the present disclosure are described in detail below with reference to the following drawings.

FIG. 1 is a schematic representation of an aircraft having an integrated system for measuring aeroelasticity of the aircraft wing, according to embodiments.

FIG. 2 is a schematic representation of a processing system suitable for use with an aeroelasticity measurement system as described herein

FIG. 3 is a flowchart illustrating operations in a method for wing twist measurement that may be performed by an aeroelasticity measurement system according to embodiments.

FIG. 4 is a schematic illustration of an aeroelasticity measurement method that may be performed by an aeroelasticity measurement system in accordance with some embodiments.

FIG. 5 is a schematic illustration of an integrated aeroelasticity measurement system, according to embodiments.

FIG. 6 is a flowchart illustrating operations performed by the integrated aeroelasticity measurement system depicted in FIG. 5, according to embodiments.

FIG. 7 is a schematic flow diagram illustrating a method to develop a flight aeroelasticity record, in accordance with embodiments.

FIG. 8 is a flowchart illustrating operations in a method to develop a vehicle structural health model generation process that is embodied in FIGS. 5 and 6.

FIG. 9 is a flowchart of the fleet vehicle structural health system model generation process that is depicted in FIGS. 5 and 6.

FIG. 10 schematic representation of an aircraft having an integrated system for measuring aeroelasticity of the aircraft wing, according to embodiments.

### DETAILED DESCRIPTION

Systems and methods which utilize an integrated aeroelasticity measurement system for vehicle condition monitoring and reporting are described herein. Specific details of certain embodiments are set forth in the following description and the associated figures to provide a thorough understanding of such embodiments. One skilled in the art will understand, however, that alternate embodiments may be practiced without several of the details described in the following description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of structures and that the aircraft wing aeroelasticity measurement system described herein is merely one exemplary application for the invention.

For the sake of brevity, conventional techniques related to inertial measurement sensors, GPS systems, navigation systems, navigation and position signal processing, data transmission, signaling, network control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to components or features being “connected” or “coupled” together. As used herein, unless expressly stated otherwise, “connected” means that one component/feature is directly joined to (or directly communicates with) another component/feature, and not necessarily mechanically. Likewise, unless expressly stated otherwise, “coupled” means that one component/feature is directly or indirectly joined to (or directly or indirectly communicates with) another component/feature, and not necessarily mechanically. Thus, although the figures may depict example arrangements of elements, additional intervening elements, devices, features, or components may be present in an actual embodiment (assuming that the functionality of the system is not adversely affected).

As used herein, a “navigation solution” refers to the position, velocity, and attitude of a measured point, relative to one or more reference axes, or relative to the earth.

As used herein, a “navigation trajectory” refers to the position, velocity, and attitude of a measured point, relative to one or more reference axes, over a period of time. A navigation trajectory can be derived from a history of navigation solutions.

As used herein, “aeroelasticity measurements” and “aeroelasticity parameters” refers to accelerations, jerk, attitudes, rates or like navigation state data. “Aeroelasticity parameters” associated with these may include altitude, airplane type, model, weight and the like.

An integrated aeroelasticity measurement system configured in accordance with the invention employs a single processor to collect data from measurement navigation units, such as inertial measurement units (“IMUs”), located at various measurement points of interest on an aircraft wing. The system also collects data from a reference IMU, which is preferably located in the aircraft fuselage. The reference IMU is treated as a fixed reference point that is not subject to twisting, bending, or displacement during flight. The example system also collects data from a GPS receiver that is capable of tracking the Wide Area Augmentation System (“WAAS”) for performance augmentation of the GPS measurements. The WAAS is one of a variety of means by which the GPS receiver solution can be augmented; any suitable technique would suffice in this application. The GPS receiver and antenna are located proximate to the reference IMU and the receiver navigation solution, measured at the antenna, is also treated as a fixed reference point, providing a navigation position and velocity solution that is integrated with that of the reference IMU.

The measurement technique described in more detail herein applies aided inertial navigation and stochastic alignment and flexure estimation algorithms that are typically used in aircraft navigation and weapon system navigation initialization. These algorithms are implemented in a unique and integrated manner that takes advantage of features typically used for other purposes and/or features that may otherwise be unused due to system bandwidth limitations.

In practice, the measurement system produces separate estimates of both static and dynamic misalignment and flexure between the reference IMU and the wing-mounted IMUs. In addition, the measurement system can estimate misalignment between the wing-mounted IMUs themselves. The static estimates provide the capability to aid in precision mounting of the inertial sensors by taking advantage of the lack of motion to process data at a higher rate relative to the in-flight data processing rate. So doing, the measurement system is able to make its estimates in the low motion environment on the ground, requiring only a rotation or taxi of the aircraft to get estimates in all three aircraft body axes.

Using the techniques described herein, the measurement system takes a problem usually solved by sensor experts (inertial sensors, photogrammetric sensors, etc.) and engineers skilled in estimation techniques, and makes its solution accessible to those unskilled in these fields. Historically, these kinds of measurements required the involvement of specialists, special software, hardware and algorithms usually directed and generated for the specific case at hand and then not used again. In contrast, the measurement system described herein integrates complex algorithms and techniques into a package that can be used by ground maintenance and aerodynamics engineers not skilled in those fields to produce reliable results on a variety of platforms without the degree of specialized work that has traditionally been necessary. In addition, the measurement system produces estimates of measurement accuracy not typically available in previous work.

Real-time, direct measurements of aeroelasticity may improve the accuracy of aircraft performance assessments. An aircraft subsystem incorporating an integrated aeroelasticity measurement system may use twist data to conduct in-flight condition-based structural health monitoring and collection of measurements at desired flight conditions for post-flight ground-based processing that over the long-term enhances ground maintenance of the vehicle, fleet maintenance and improves structural design for next generation aircraft. Compiling these measurements in post-flight environment adds the dimension of time, in addition to the three dimensions of aeroelastic measurement, to the data and may provide a view into the way individual aircraft and entire aircraft fleets age. This knowledge may contribute to updated design models and improvements in the next generation of aircraft. It also provides the ability to define thresholds for in-flight structural health condition assessment.

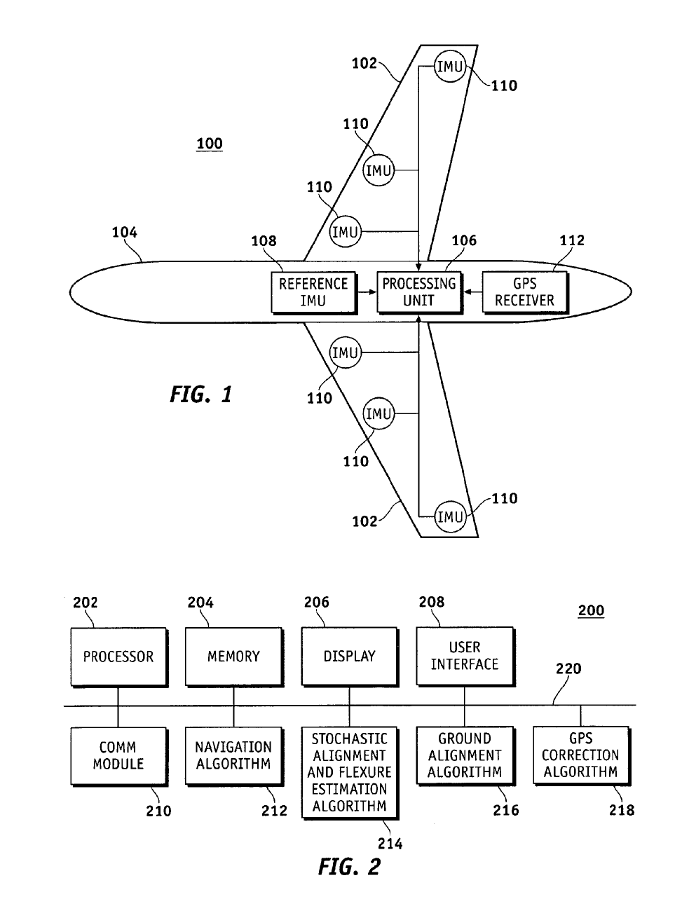

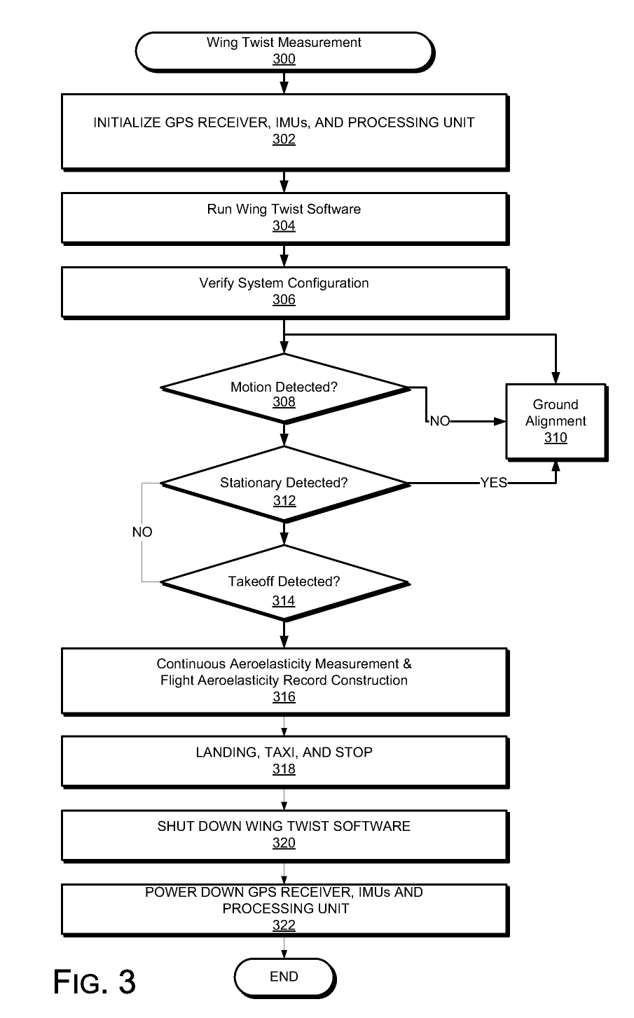

FIG. 1 is a simplified schematic representation of an aircraft 100 having an integrated system for measuring aeroelasticity of the aircraft wings 102, and FIG. 2 is a schematic representation of a processing unit 200 suitable for use with an aeroelasticity measurement system as described herein. The various illustrative blocks, modules, processing logic, and circuits described in connection with processing unit 200 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

Referring to FIG. 1, aircraft 100 generally includes a body 104 and wings 102 attached to body 104. During flight, wings 102 may deflect and/or twist relative to their respective chord lines (as mentioned above). The amount of deflection and twist may vary during flight depending upon various factors such as airspeed, weather conditions, the volume of fuel in wings 102, loading of aircraft 100, the flight path of aircraft 100, and the like. The aeroelasticity measurement system described herein is a commercial aircraft subsystem that can be installed in aircraft 100 to collect in-flight aeroelasticity (e.g., wing twist and body bending) data and used to monitor structural aging of the aircraft over time as well as individual events such as a hard landing, a wing impact, wind shear, turbulence and the like. The example aeroelasticity measurement system shown in FIG. 1 generally includes a processing unit 106, a reference IMU 108 coupled to processing unit 106, a plurality of IMUs 110 coupled to processing unit 106, and a GPS receiver 112 coupled to processing unit 106. A practical embodiment may include any number of measurement IMUs 110 located throughout aircraft 100, and the location of such IMUs 110 need not be restricted to wings 102.

Processing unit 106, which is described in more detail below in connection with FIG. 2, functions as a centralized data collection point and an integrated data processing component for the aeroelasticity measurement system. Briefly, processing unit 106 is suitably configured to collect inertial measurement data from reference IMU 108 and from measurement IMUs 110, compute a reference navigation solution, compute measurement navigation solutions, and resolve wing twist and/or wing deflection from the navigation solutions, in a centralized and real-time manner that need not require post processing of the navigation data. In practice, processing unit 106 may be realized as a general purpose computing device, such as a personal computer having sufficient memory capacity, processing power and speed, hard drive storage space, user interface devices, and graphics capabilities. Processing unit 106 may utilize a laptop computer and/or any portable computing device that can be conveniently installed in, and removed from, aircraft 100. Alternatively, processing unit 106 may be incorporated into an aircraft-mounted computing device or processing system of aircraft 100.

Reference IMU 108 is coupled to processing unit 106 via any suitable data connection. In the example embodiment, reference navigation unit 108 is coupled to processing unit 106 via a serial data connection (such as an RS-422 compliant connection). In operation, reference IMU 108 generates inertial measurement data for a reference location on aircraft 100. In the example embodiment where wing twist and deflection is measured, reference IMU 108 is mounted in body 104 of aircraft 100 and is treated as a fixed reference point. In other words, the reference location corresponding to the reference navigation data is a location in body 104. When deployed, reference IMU 108 is mounted in a suitable manner such that its housing does not move relative to the reference point of aircraft 100. In other words, reference IMU 108 facilitates “strapdown” navigation (in contrast to a navigation component mounted to a gimbal).

In one practical embodiment, the reference IMU 108 data includes measured angle change and measured velocity change for a plurality of axes. In particular, reference navigation unit 108 may be realized as an IMU having three orthogonal axes corresponding to three sensitive directions. An example IMU employs a combination of gyros and accelerometers to measure angle and velocity change over an interval of time (usually 10 milliseconds or less). Typically, an IMU provides three-axis measurements taken from an orthogonal triad of gyros and accelerometers. This is accomplished by sampling the inertial instruments at a designated rate (for example, 1000 Hz or higher) and applying compensations for non-commutativity to accumulate and provide the data at a lower rate. Non-commutativity refers to the fact that the order of the angle and velocity change is not commutative and also not known over the interval of measurement. In practice, the aeroelasticity measurement system may utilize any suitable IMU technology, and the specific operation of IMUs will not be described in detail herein.

Using IMU technologies, therefore, reference IMU 108 is capable of measuring movement and velocity of the reference location relative to the three axes. Processing unit 106 may sample and integrate the data stream of reference IMU 108 at a specified rate, and processing unit 106 may produce the integrated reference navigation data (e.g., position, velocity, attitude) at the same rate. For example, reference navigation unit 108 may be configured to read the reference IMU 108 data at a rate of 100 Hz and provide an integrated reference navigation state (e.g., position, velocity attitude) at 100 Hz (that may be corrected at intervals by GPS measurements) through the strapdown aided inertial navigation process.

If IMU 108 is realized as a practical IMU, then the accuracy of the navigation data may drift over time (even though the IMU is very accurate over short periods of time). In contrast, the accuracy of GPS data does not drift over time, however, each individual GPS reading may not be very precise. The example aeroelasticity measurement system takes advantage of the long term stability of GPS systems and utilizes GPS data to improve the accuracy of the reference navigation solution and the reference trajectory derived from the reference IMU data. As depicted in FIG. 1, GPS receiver 112 may be coupled to processing unit 106 using a suitable interface, such as an RS-422 serial data connection. In the example embodiment, GPS receiver 112 is configured to provide GPS data for the reference location. Consequently, the antenna for GPS receiver 112 is preferably located near to reference IMU 108. In practical embodiments, GPS receiver 112 can be a civilian grade commercial GPS receiver having access to WAAS correction data or other means of enhancing the receiver solution; or it may rely on the standalone receiver solution alone.

Processing unit 106 receives the GPS data from GPS receiver 112, along with the inertial measurement data from reference IMU 108, and processes the GPS data and the reference IMU 108 data in an appropriate manner to generate a reference navigation solution that includes accurate position, velocity, and attitude data for the reference location. In this regard, processing unit 106 generates the reference navigation solution based upon the reference navigation data and based upon the GPS data. In practice, processing unit 106 generates reference navigation solutions at the same rate at which the reference navigation data is sampled (100 Hz in this example). Both measurement and reference navigation solutions are integrated over time, according to the frames of IMU data received. There is a navigation solution for each new frame of IMU data; the integration of these data frames according to strapdown navigation techniques results in a new navigation solution current at the time of validity of the latest frame of data.

Reference IMU 108, GPS receiver 112, and processing unit 106 function as a reference navigation system for the aeroelasticity measurement system, where the reference system obtains a reference trajectory that tracks the reference location during aircraft flight. Ultimately, wing twist and wing deflection is measured relative to the reference trajectory, which represents the position, velocity, and attitude of reference IMU 108 over time. Processing unit 106 receives the raw reference IMU data from reference IMU 108, and integrates the IMU data to generate the reference navigation solution. The GPS data is used to keep the reference trajectory accurate. In the example embodiment, the reference navigation solution is generated using a Kalman filter algorithm to estimate the best state of the navigation system based on both inertial and GPS data. The inertial data is accurate over the short term, while the GPS data is reliably accurate (but noisy) over the long term and does not provide attitude data. The Kalman filter takes measurements from both sources and produces the best estimate of the navigation state.

Each measurement IMU 110 is coupled to processing unit 106 via any suitable data connection. In the example embodiment, each measurement IMU 110 is coupled to processing unit 106 via a serial data connection (such as an RS-422 compliant connection). In operation, each measurement IMU 110 generates inertial measurement data for a measurement location on aircraft 100. In the example embodiment where wing twist and deflection is measured, each measurement IMU 110 is mounted in the wings 102 of aircraft 100. For example, each measurement navigation unit 110 may be installed in a pocket or other suitable location within the interior space of the wings 102. Each measurement IMU 110 is mounted in a suitable manner such that its housing does not move relative to the respective measurement point of aircraft 100. In other words, the measurement IMUs 110 facilitate “strapdown” navigation for the aeroelasticity measurement system.

In the example embodiment, the measurement navigation data includes measured angle change and measured velocity change for a plurality of axes. In particular, each measurement IMU 110 may be realized as an IMU having three orthogonal axes corresponding to three sensitive directions. The IMU hardware utilized for measurement IMUs 110 may be the same as the IMU hardware utilized for reference IMUs 108 (described above). Each measurement IMU 110 is capable of measuring movement and velocity of its respective measurement location relative to the three axes. Each measurement IMU 110 may sample or obtain its inertial measurement data at a specified rate, and processing unit 106 may receive the sampled inertial measurement data at the same rate. For example, each measurement IMU 110 may be configured to read the measurement navigation data at a rate of 100 Hz. In a practical embodiment, the IMU samples its inertial instruments to obtain data on angle and velocity change of the unit over an interval of time that is then reported out to the navigator (reference or measurement unit). The processing unit 106 implements the reference and measurement navigators in its computer code and collects the frames of IMU data as they become available. A frame of IMU data includes the angle and velocity change measured over the output interval (e.g., 10 milliseconds for a 100 Hz unit).

Processing unit 106 is suitably configured to obtain the inertial measurement data from measurement IMUs 110 and to generate measurement navigation solutions for the respective measurement locations. Each measurement navigation solution is based upon the inertial measurement data for the particular measurement location, and each measurement navigation solution includes position, velocity, and attitude information for the respective measurement location. Thus, the example shown in FIG. 1 would generate six measurement navigation solutions—one for each wing-mounted measurement IMU. The generation of the measurement navigation solutions is similar to the generation of the reference navigation solution described above in connection with the reference system. In practice, processing unit 106 generates measurement navigation solutions at the same rate at which the measurement navigation data is sampled (100 Hz in this example). Again, the difference between the reference and measurement navigators is that the reference navigator keeps itself stable and accurate using GPS measurements while the measurement navigator keeps itself stable and accurate using the reference navigation state. The measurement navigator and Kalman filter processing serves to keep the measurement navigator aligned to the reference and estimate the current difference (attitude and flexure) between the two.

Processing unit 106 is also configured to derive a corrected measurement solution from the reference navigation solution and the measurement navigation solutions. The corrected measurement solution indicates aeroelasticity of the measurement locations relative to the reference location. In the example embodiment described herein, processing unit 106 performs stochastic alignment and flexure estimation on the reference navigation solution and the measurement navigation solutions to obtain the corrected measurement solution. In practice, the corrected measurement solution represents the best estimate of the navigation state at the measurement IMU. The measurement Kalman filter estimates the attitude and flexure between the two, allowing the measurement unit to update itself (correct its drift) based on the reference solution. This corresponds to the wing twist and flexure estimate, and is the means by which the measurement navigation solution is related to the reference solution. Processing unit 106 may be configured to generate the corrected measurement solution at a rate that differs from the data sampling rate. The corrected measurement solution and the aeroelasticity estimate may be generated at a rate that is less than the IMU data sampling rate (generated at 10 Hz in the example embodiment where the navigation data is sampled at 100 Hz). Furthermore, processing unit 106 may be configured to resolve wing twist and/or wing deflection from the corrected measurement solution via the mechanism of a stochastic alignment and flexure estimation algorithm. In a practical deployment, the wing twist and/or wing deflection information can be provided to an operator in any suitable format, e.g., a graphical display, a printed report, disk file, or the like. The information may also be sent to another computing device or system in any suitable electronic format via TCP/IP, ARINC 429, or other network protocol.

FIG. 2 is a schematic representation of processing unit 200, which may be suitable for use with an aeroelasticity measurement system as described herein. Processing unit 200 generally includes a processor or controller 202, memory 204, a display element 206, one or more user interface components 208, a communication module 210, a navigation algorithm 212, a stochastic alignment and flexure estimation algorithm 214, a ground alignment algorithm 216, and a GPS correction algorithm 218. Processing unit 200 may also include a number of conventional hardware, software, firmware, or logical elements found in general purpose computing architectures (not shown). These elements may be coupled together or otherwise able to communicate with each other via a bus 220 or any suitable interconnection architecture to support the functionality of processing unit 200. In an actual deployment, communication module 210, navigation algorithm 212, stochastic alignment and flexure estimation algorithm 214, ground alignment algorithm 216, and GPS correction algorithm 218 (or portions thereof) are realized as processing logic or logical elements, and such processing logic may be realized as one or more pieces of software/firmware. For example, the processing algorithms may be implemented in a software application executed by processor 202.

Display element 206 conveys visual information to the user under the control of processor 202. In practice, display element 206 may be realized as a conventional computer monitor or laptop computer display screen, or as a specialized display in the aircraft cockpit. Display element 206 can be used to display the aeroelasticity measurement results to the operator. Processing unit 200 may also include user interface component(s) 208 that accommodates user inputs and/or conveys audible or tactile information to the user under the control of processor 202. For example, user interface components 208 may include, without limitation: a keyboard, a mouse or other pointing device, a touchpad, or the like.

Communication module 210 is suitably configured to manage data communication with the reference navigation unit and the measurement navigation units in accordance with at least one data communication protocol. In the example embodiment, communication module 210 provides a serial data interface for processing unit 200. Of course, communication module 210 may be configured to support any number of standardized data communication protocols such as, without limitation: ARINC 429, 629, 664, MIL-STD-1553, RS-422; Bluetooth; IEEE 802.11 (any variation thereof); Ethernet; IEEE 1394 (Firewire); GPRS; USB; IEEE 802.15.4 (ZigBee); or IrDA (infrared). Communication module 210 may be realized with hardware, software, and/or firmware using known techniques and technologies.

Navigation algorithm 212, stochastic alignment and flexure estimation algorithm 214, ground alignment algorithm 216, and GPS correction algorithm 218 represent procedures and techniques executed by processing unit 200 while performing aeroelasticity measurements as described herein. These logical elements enable processing unit 200 to collect and process data in real-time without having to rely on post-processing techniques. These elements and algorithms are described in more detail below.

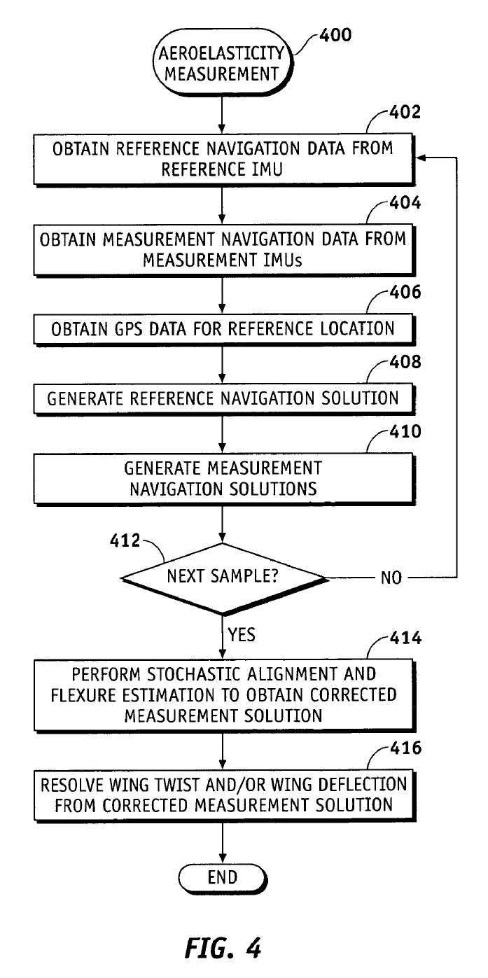

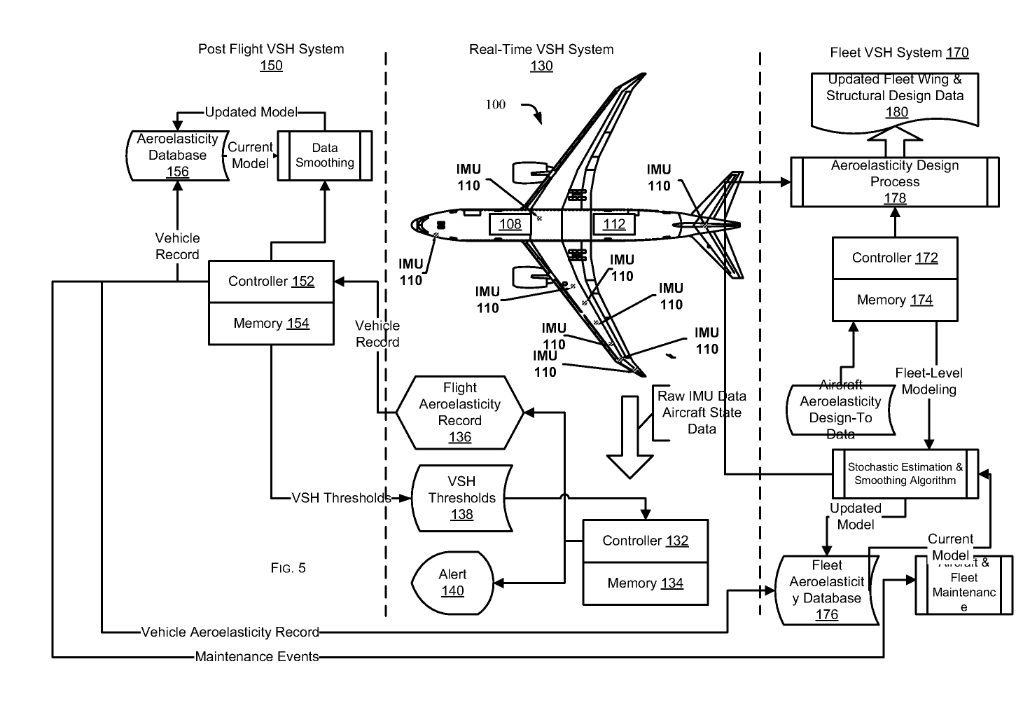

FIG. 3 is a flow chart of an example wing twist measurement process 300 that may be performed by an aeroelasticity measurement system as described herein, and FIG. 4 is a flow chart of an example aeroelasticity measurement process 400 that may be performed by an aeroelasticity measurement system as described herein. Process 400 may be incorporated into process 300 for execution as described in more detail below. The various tasks performed in connection with process 300 and process 400 may be performed by software, hardware, firmware, or any combination thereof. For illustrative purposes, the following description of process 300 and process 400 may refer to elements mentioned above in connection with FIG. 1 and FIG. 2. In practical embodiments, portions of process 300 or process 400 may be performed by different elements of the described system, e.g., processing unit 106, reference IMU 108, measurement IMU 110, or GPS receiver 112. It should be appreciated that process 300 (and/or process 400) may include any number of additional or alternative tasks, the tasks shown in FIG. 3 and FIG. 4 need not be performed in the illustrated order, and process 300 (and/or process 400) may be incorporated into a more comprehensive procedure or process having additional functionality not described in detail herein. For example, reference IMU 108 and measurement IMUs 110 may be inertial navigators (rather than measurement units) thereby federating the processing done in processing unit 106 of FIG. 1.

The steps of a method or algorithm described in connection with the embodiments disclosed herein may be embodied directly in hardware, in firmware, in a software module executed by a processor, or in any practical combination thereof. A software module may reside in RAM memory, flash memory, ROM memory, EPROM memory, EEPROM memory, registers, a hard disk, a removable disk, a CD-ROM, or any other form of storage medium known in the art. In this regard, an exemplary storage medium can be coupled to a processor such that the processor can read information from, and write information to, the storage medium. In the alternative, the storage medium may be integral to the processor. As an example, the processor and the storage medium may reside in an ASIC. In a practical embodiment, these elements and components may reside at, or communicate with, processing unit 106.

The example measurement system utilizes strapdown navigation at 100 Hz, a GPS/inertial Kalman filter and a low-motion alignment Kalman filter. The reference IMU drives a GPS/inertial navigator from which a free inertial solution is also derived. The measurement IMUs each drive a strapdown navigator that is continually aligned to the reference IMU via the low-motion alignment algorithm. The three-axis wing twist and wing displacement data can be displayed and recorded for at least two IMUs, one reference and one measurement. The actual number of wing-mounted measurement IMUs can vary to suit the needs of the given application, and a practical measurement system can handle as many measurement IMUs as the processor can sustain.

Referring to FIG. 3, wing twist measurement process 300 represents an example procedure for obtaining wing twist and/or wing deflection data. Process 300 assumes that an integrated aeroelasticity measurement system as described above is installed in the aircraft. In other words, a reference IMU is mounted in a suitable location in the aircraft body, a plurality of measurement IMUs are mounted in suitable locations in the aircraft wings, a GPS receiver is mounted in a suitable location in the aircraft body, and a processing unit (having the necessary processing capabilities) is coupled to the respective system components to receive reference navigation data, measurement navigation data, and GPS data. In a practical embodiment, the measurement system may support a precision mounting mode that is utilized to assist in the mounting of the measurement IMUs in the aircraft wings. The mounting procedure eliminates the need to perform optical alignment procedures. Briefly, the precision mounting procedure records the static alignment of the measurement IMUs relative to the reference IMU, along with the orientation of the measurement IMUs relative to the reference IMU (due to the directional nature of the IMUs). This mounting procedure obtains the roll, pitch, and yaw of the measurement IMUs relative to the reference IMU. The mounting procedure also enables translation of the measurement IMU data to respective modeled measurement points, which in turn facilitates the computation of wing twist and wing deflection relative to designated reference points or lines on the aircraft (e.g., the chord line of the wings).

Wing twist measurement process 300 may begin by initializing the GPS receiver, the IMUs, and the processing unit (task 302). The hardware components are powered up during task 302, which may be performed by an operator. In response to task 302, the GPS receiver begins the tracking process and the IMUs begin to output their respective navigation data at a specified rate (100 Hz in the example embodiment described above). After system initialization, the operator can run the wing twist software (task 304), which may prompt the operator to confirm or verify the system configuration (task 306). The system configuration refers to the number of measurement IMUs deployed, the types of IMUs deployed, the accuracy of the system components, and the like. The system is ready to take measurements after the system configuration has been verified.

The system may test whether the aircraft is in motion (query task 308). In a practical embodiment, “motion” may refer to a specified velocity or movement threshold. For example, “motion” may be defined as three feet of movement in one second as determined by a moving window sum of absolute values of raw delta velocity readings from which gravity is removed. Moreover, once motion has been detected, “stationary” may be defined in terms of another velocity or movement threshold. For example, “stationary” may be defined as motion of less than one foot in one second.

If motion is not detected by query task 308, then wing twist measurement process 300 may perform a suitable ground alignment procedure (task 310) to determine the position and attitude of the reference IMU. Ground alignment algorithm 216 (see FIG. 2) may be executed during task 310. Ground alignment algorithm 216 compares the reference navigation solution to zero velocity and, due to rotation of the earth and the effect of gravity, ground alignment algorithm 216 can determine the orientation of the aircraft relative to true north. In practice, the ground alignment procedure is only applicable to the reference trajectory. In one example embodiment, the reference IMU begins ground alignment in an altitude-hold mode (since no air data is available, and until GPS altitude data is available), based upon the last available position and heading. During the ground alignment procedure, the reference IMU employs a 1 Hz zero velocity update rate in an altitude-hold mode (based on initial altitude) until the GPS receiver provides an altitude reference, after which the GPS altitude is used to damp the vertical axis. When the first GPS fix is available, a position check is made and ground alignment restarts with a new position if there is a significant latitude change.

If, however, motion is detected by query task 308 (e.g., at least three feet in one second), then wing twist measurement process 300 exits the ground alignment mode and the reference IMU enters the free inertial mode. The free inertial mode refers to the processing of the reference navigation data to generate the reference navigation solution. In addition, the measurement IMUs can begin continuous alignment to the reference IMU once degraded navigation is ready, using the same initial position and heading. In this context, “degraded navigation” represents the earliest possible time at which the reference navigator can sustain navigation albeit with less accuracy. Normally a full ground alignment process is completed when the estimated navigation error decreases as ground alignment refines the navigation state and the estimated error passes through a threshold value that is typically the specification value for the IMU. That is, a navigation grade IMU is typically capable of 0.8 nautical miles per hour navigation accuracy but this accuracy will only be achieved if the navigator designed around the IMU is properly initialized and aligned. Alignment is a process whose accuracy increases over time as a function of inertial sensor accuracy and the algorithm parameters. As alignment time increases, navigation accuracy increases until it reaches the threshold capability of the IMU and alignment algorithms; the process can take from 30 seconds to 45 minutes to reach the specified accuracy, depending on the initial conditions (for example, if heading and latitude are well known alignment is quick).

Measurement units can begin their navigation and estimation process (at the earliest) when the reference unit has progressed to a degraded navigation state. As the reference unit continues to align and its accuracy estimate continues to decrease (meaning it can navigate more accurately), the measurement units correct themselves accordingly (that is, they receive information on corrections the reference has made to its state and apply these in turn to their own state).

If process 300 subsequently detects a stationary condition (query task 312), then task 310 is re-entered to continue ground alignment. As mentioned above, “stationary” is defined as motion of less than one foot in one second for the example embodiment.

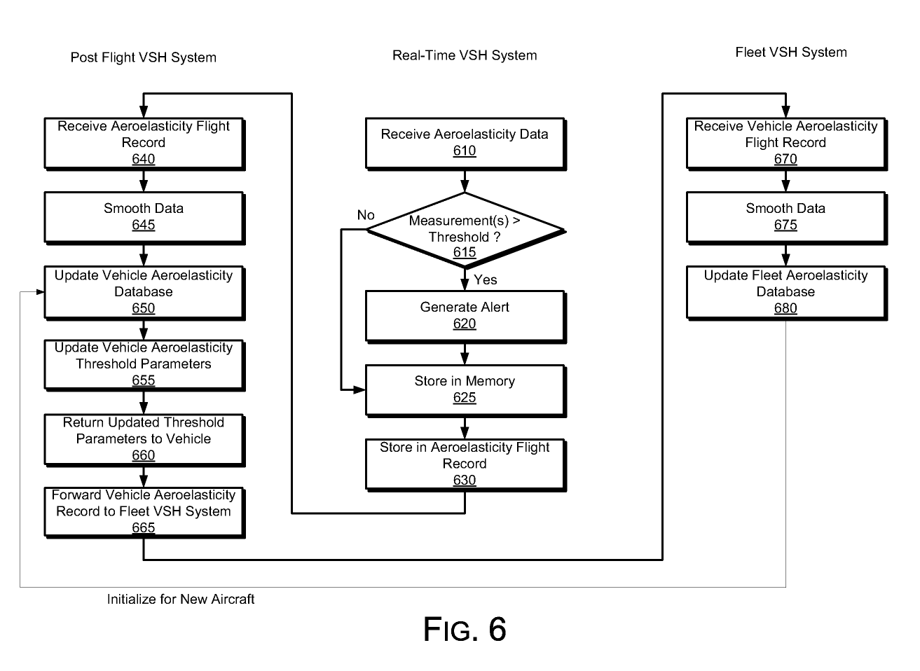

In the example embodiment, the actual in-flight testing does not occur until takeoff is detected (query task 314). In practice, “takeoff” may be defined to be a specific speed threshold. In this regard, the example embodiment defines “takeoff” as an aircraft speed that exceeds 50 knots. When takeoff is detected, the free inertial mode of the reference IMU is assisted with the full compliment of GPS data (as opposed to an altitude update only) to provide a reference trajectory having improved accuracy. GPS correction algorithm 218 may be executed at this time (see FIG. 2). Upon takeoff, wing twist measurement process 300 performs aeroelasticity measurement (operation 316) and builds the Flight Aeroelasticity Record (136 of FIG. 5). During the flight, an operator may, but need not, monitor and control the measurement system. For example, the operator can view the results in a suitable format on a display. If GPS data is lost for more than a designated period of time (for example, 60 seconds), then the reference IMU may enter an altitude-hold mode to stabilize the vertical channel until GPS data is again available. During the flight, the system can process and store data indicative of the parameters, quantities, and measurements described herein, including, without limitation: the navigation data, navigation solutions, reference trajectory, wing twist, wing deflection, and/or aircraft aeroelasticity.

During landing and taxi (task 318) the system continues to run in the GPS aided mode. The system may again enter the ground alignment mode when the aircraft stops and a stationary condition is detected. If an avionics shutdown is commanded by the pilots, the system shuts down the software (operation 322) and powers down the GPS receiver, the IMUs, and the processing unit (operation 324). Prior to shutdown, the software may save the last navigation state for use at startup. If there is no shutdown the system returns to ground alignment 310. Upon completion of the flight the Flight Aeroelasticity Record (see, reference numeral 136 of FIG. 5) can be removed from the aircraft for ground based processing of FIG. 5 150 and 170. Furthermore, the ground-based system of FIG. 5 150 may support a playback mode for examination of recorded data after completion of the flight.

Referring to FIG. 4, aeroelasticity measurement process 400 represents one example technique for collecting and processing IMU data from a measurement system as described herein. Process 400 may be performed, for example, during the flight portion of wing twist measurement process 300. In practice, process 400 is cyclical at a rate of 10 Hz or more. A cycle involves access to reference unit navigation data over the previous interval (0.1 seconds, for example). A difference is formed between measurement and reference navigation solutions at the end of the interval. The difference is fed to a stochastic alignment and flexure algorithm that estimates the current attitude and flexure between the two units. The measurement navigator is then corrected for the error portion of this estimate, its navigation state reset consistent with the reference unit, and the attitude and flexure estimates are output as the desired aeroelasticity data.

Aeroelasticity measurement process 400 may begin by obtaining reference navigation data from the reference IMU (task 402). In practice, the reference navigation data includes position, velocity, and attitude data indicative of the measured angle change and measured velocity change for the three sensitive axes of the reference IMU. In addition, process 400 obtains measurement navigation data from the measurement IMUs (task 404), which are wing-mounted in the example embodiment described above. As with the reference navigation data, the measurement navigation data includes position, velocity, and attitude data indicative of the measured angle change and measured velocity change for the three sensitive axes of each measurement IMU. As mentioned above, the reference navigation data and the measurement navigation data may be generated at a specified rate, such as 100 Hz in this example.

The preferred embodiment also obtains GPS data for the reference location (task 406) for use in generating the reference trajectory. In this regard, process 400 may generate the reference navigation solution (task 408) by processing the reference navigation data and the GPS data. In practice, the reference navigation solution includes position, velocity, and attitude data for the reference location. The reference navigation solution is generated in two distinct segments (ground and in-flight) from reference IMU inertial and GPS receiver data. At startup, on the ground and stationary, the reference navigation solution is estimated through the ground alignment Kalman filtering process, which may be punctuated by intervals when the plane taxis but does not exceed the 50 knot threshold. The ground alignment process continues as long as the plane is stationary, with the end result being the reference navigator is prepared to navigate at its specification accuracy. During taxi operations of less than 50 knots, the reference navigator is not aligning but navigating using GPS altitude (only) updates to damp the vertical position and velocity. When 50 knots are exceeded, the full compliment of GPS data (3-axis position and velocity) is applied to the Kalman filtering process and thereafter the reference navigator solution is derived from inertial and GPS data blended by the Kalman filter into a single navigation state estimate.

Again, the GPS data provides long term accuracy for the reference navigation solution, while the reference navigation data provides short term accuracy. Process 400 also generates measurement navigation solutions for the respective measurement IMUs (task 410). The measurement navigation solutions are generated by processing the respective measurement navigation data, and each measurement navigation solution includes position, velocity, and attitude data for the given measurement location. The reference navigation solution and the measurement navigation solutions may be generated at a specified rate, such as 100 Hz in this example.

As described above, the aeroelasticity measurement system may collect the measurement data at a first sampling rate (e.g., 100 Hz) and process the measurement data at a second sampling rate (e.g., 10 Hz). At the 10 Hz rate, the processing unit compares the measurement data to the reference data. Thus, if the next data sample is to be processed (query task 412), then process 400 continues. Otherwise, task 402 may be re-entered to enable process 400 to gather data at the 100 Hz rate. In the example embodiment, the processing unit performs a stochastic alignment and flexure estimation procedure on the reference navigation solution and the measurement navigation solutions to obtain corrected measurement solutions for the measurement locations (task 414). Generally, a corrected measurement solution represents the navigation state at the measurement IMU and the estimate of attitude and flexure represents a difference between the reference navigation solution and the respective measurement navigation solution, which is the desired aeroelasticity measurement. The direct difference between reference and measurement units may include contributions from instrument errors, timing errors, wing twist, and wing deflection, but the final estimate produced by the stochastic alignment and flexure algorithm separates these out to indicate aeroelasticity of the respective measurement location relative to the reference location.

In one practical embodiment, task 414 applies Kalman filtering to the reference navigation solution and the measurement navigation solution to obtain the corrected measurement solutions. Kalman filters and Kalman filtering techniques are generally known to those skilled in the art and, therefore, such techniques will not be described in detail herein. Briefly, a Kalman filter is a stochastic algorithm that takes measurements, complete or partial, of a system state and produces from all the measurements the best estimate of system state including the errors in the system. The algorithm contains state equations which comprehensively render the system into a math model that includes system errors, measurement errors and state transition equations. The algorithm retains a memory (so to speak) of past events in its covariance matrix, which is propagated in time and updated according to the information in each measurement made on the system state. After a period of time the Kalman filter estimate will contain information on the system errors that improves the system state estimate over the quality that could be obtained from any combination of the measurements alone.

For example, the navigation state includes position, velocity and attitude at any given time. The IMU provides a measure of angle and velocity change over small time intervals. These data can be integrated to yield position, velocity, and attitude but this is accurate primarily in the short term and suffers from drift errors in the inertial instruments that cause an ever increasing error in the navigation solution to the point it would be useless for realistic applications after a period of time (how much time is a function of instrument accuracy). The GPS receiver provides a position and velocity (but not attitude) solution valid at its antenna location that is consistently over time accurate but subject to small errors that act as noise rather than drift. Measurements from an IMU and a GPS receiver can be combined in a Kalman filter that models the errors, which are well known and mathematically characterized, estimates them, and removes their effect to produce the best statistical estimate of the navigation state as time passes. The short term accuracy of the IMU is effectively combined with the long term accuracy of GPS to produce a navigation state without long term drift effects of inertial data or the noisy short-term variation of GPS data.

It should be appreciated that Kalman filtering is merely one practical way of implementing a stochastic alignment and flexure estimation algorithm, and that any suitable technique can be utilized in lieu of Kalman filtering to measure the static and dynamic alignment of the measurement IMUs relative to the reference IMU. For example a least squares technique can be employed instead of Kalman filtering.

Aeroelasticity measurement process 400 can resolve the wing twist and/or the wing deflection information from the corrected measurement solution (task 416) using suitable processing techniques. In the example embodiment, the aeroelasticity data is resolved from measurement and reference unit differencing of position, velocity, and attitude. The difference, at a 10 Hz rate, contains the effects of instrument inertial errors, timing errors, static and dynamic attitude difference and flexure. The stochastic alignment and flexure algorithm separates these out and estimates them, providing a correction to the measurement navigation state and the twist and flexure data that is desired. The wing twist/deflection data can then be displayed, saved, printed, or otherwise presented to an operator for review.

The reference navigation unit and the measurement navigation units for the example system described above navigate with respect to the earth (absolute position). An alternate embodiment, however, may employ measurement navigation units that track motion relative to the reference navigation unit. Thus, the navigation solution can be an absolute earth-relative solution as described above or a solution that tracks one point relative to another (reference) point whose absolute earth-relative position is unknown. In other words, for purposes of aeroelasticity measurement an absolute earth-relative solution is not essential. Furthermore one skilled in the art will recognize that rather than inertial measurement units an inertial navigator could be used in FIG. 1 110, an alternate embodiment that simply federates the processing to accomplish the same end. Likewise a gimbaled inertial sensor might be used in an alternate embodiment. In practice strapdown IMUs 110 of FIG. 1 may be preferable because their physical size is smaller.

In some embodiments as seen in FIG. 5, an integrated aeroelasticity measurement system is the core around which a three-part vehicle structural health management system (VSHMS) is constructed. In the first part, Real Time VSH System 130, data collected by the integrated aeroelasticity measurement system encapsulated in Controller 132 and memory 134 may be processed in real time in-flight to generate one or more aeroelasticity flight records which reflect aeroelasticity data collected by the integrated aeroelasticity measurement system over the course of a flight operation, or a portion thereof. The aeroelasticity flight record(s) may be stored in a persistent storage medium, e.g., the memory module 204 of the processing unit 200 onboard the aircraft 100. The aeroelasticity flight record(s) may in the second part (Post Flight VSH System 150) be provided to a vehicle health monitoring system remote from the aircraft which processes the aeroelasticity flight record(s) to compile an aeroelasticity database for the aircraft. In addition, the vehicle health monitoring system may determine one or more vehicle structural health thresholds from the data in the aeroelasticity database consisting of sets of cruise conditions of interest for capturing normal flight events and three sigma (or other desirable confidence) conditions for anomalous events. By way of example, a three sigma condition is one not seen 99.9 percent of the time. The structural health thresholds may be returned to the aircraft and subsequently may be used to generate alerts when one or more aeroelasticity measurements exceed a threshold. In addition, aeroelasticity flight record(s) and structural health thresholds may be forwarded (the third part Fleet VSH System 170) to a structural health management system for the fleet of vehicles. The aeroelasticity flight record(s) and structural health thresholds may be used for fleet maintenance and for future design considerations.

Structural components, data objects, and operations of one embodiment of an integrated aeroelasticity measurement system will be explained with reference to FIGS. 5-9. Referring first to FIGS. 5 and 6, an integrated aeroelasticity measurement system may comprise a real-time vehicle structural health system (VHS) 130, a post-flight vehicle structural health system 150, and a fleet vehicle structural health system 170. In practice, the three systems may be implemented as computer-based systems in which logic instructions (e.g., software) residing in a memory module may be executed on a processor or controller. Alternatively, the logic instructions may be firmware executable on a programmable device such as a field programmable gate array (FPGA) or may be reduced to hard circuitry in a fixed programmed device such as an application specific integrated circuit (ASIC). The particular implementation of the logic instructions is not critical.

In use, at operation 610 the real real-time vehicle structural health system 130 receives inputs from the aeroelasticity measurement system on the aircraft 100. As described above, the real-time vehicle structural health system receives (operation 610) aeroelasticity data from inertial measurement units (IMUs) 110 positioned on the aircraft 100 and may receive data from one or more reference navigation units 108 and GPS units 112 on the aircraft 100. The inputs may be collected in real-time and may comprise at least one of navigation data, altitude data, data regarding the weight of the aircraft or distributions thereof, and inertial measurement data. Airplane type, line number (for unique identification purposes) or like information, and other relevant information may be included as well. The data may be stored in a memory module 134. The incoming data stream is assessed for conditions that meet those useful to structural health maintenance, and it is the conditions that are saved. The entire real time data stream may or may not be saved, as desired by system configuration, to eliminate the mass of irrelevant data. Conditions useful to structural health maintenance are those which exceed a measurement threshold or which comprise a structural measurement at a specific aircraft condition (altitude, weight, speed) for which long term data is desired. In other words typical conditions may be cruise at different selected altitudes and speeds or they may be unusual events marked by exceeding a threshold for the measurement point on the structure.

If, at operation 615, one or more of the measurements received from the IMUs 110 on the aircraft 100 exceeds a vehicle structural health threshold 138 then control passes to operation 620 and the controller 132 generates an alert 140. In some embodiments the alert may be presented in real-time, e.g., by way of an audible alert and/or a visible alert to a pilot or other aircraft personnel. In other embodiments the alert may be logged in memory 134 for subsequent presentation.

By contrast, if at operation 615 the measurements received from the IMUs 110 on the aircraft 100 do not exceed a threshold then control passes to operation 625 and the data received by the controller 132 is stored in memory module 134. At operation 630 the controller 132 compiles the data inputs into a flight aeroelasticity record 136, which may be stored in a suitable data structure in memory 134. In use, the operations 610 through 630 may be repeated throughout a flight operation for the aircraft 100. Thus, the aeroelasticity flight record 136 may comprise aeroelasticity data collected over the course of the entire flight, or any portion thereof, specifically those portions assessed as conditions of interest for creation of the Vehicle Aeroelasticity Record or marking an event for condition-based ground maintenance.

The flight aeroelasticity record 136 is provided to the post-flight vehicle structural health system 150. In some embodiments the flight aeroelasticity record 136 may be communicated to the post-flight structural health system 150 via a wireless communication link between the aircraft 100 and the post-flight structural health system 150. Such communication may occur during flight operation or after flight operations have terminated. In some embodiments the flight aeroelasticity record 136 may be communicated to the post-flight structural health system 150 via a wired communication link between the aircraft 100 and the post-flight structural health system 150, for example, during servicing operations performed on the aircraft 100.

At operation 640 the post-flight structural health system 150 receives the flight aeroelasticity record 136, which may be stored in the memory 154. At operation 645 the controller 152 implements a data smoothing operation which utilizes data from the existing aeroelasticity database 156 for the aircraft 100 and the data received from the current flight operation of the aircraft 100. The output of data smoothing operation is used to update the aeroelasticity database 156, at operation 650, which may be stored in memory 154. Data from the aeroelasticity database 156 may be used to construct or update one or more vehicle structural health (VHS) thresholds 138, at operation 655. The updated vehicle structural health thresholds 138 may be returned (operation 660) back to the aircraft 100 and may be stored in the memory module 134. In subsequent flight operations aeroelasticity measurements may be checked against the updated vehicle structural health thresholds 138. At operation 665 the vehicle aeroelasticity record is forwarded to a fleet vehicle structural health system 170.

At initialization the Post Flight System 150 uses design data for the aircraft (that may have been provided at least in part through the operation of Fleet VSH System 170) and the current model is based on design data alone, but as flights proceed and Flight Aeroelasticity Records 136 are processed from these, the model is updated through the cyclical stochastic data smoothing process and aeroelasticity database 156 reflects the characteristics of the aircraft whose data is used to construct it. As data is collected the dimension of time, in addition to the usual three dimensions of the aircraft body frame, provides a view of the aircraft structure as it ages. From this view the vehicle structural health thresholds 138 are derived, and as the model evolves in time the thresholds may change in response. Therefore the process self-tailors across the life of the aircraft to the current conditions.

In some embodiments the post-flight vehicle structural health system 150 may also forward a notification of one or more condition-based maintenance events to the fleet vehicle structural health system 170. Aeroelasticity data collected by the real-time vehicle health system 130 may be used to notify pilots and/or ground crews of events that may trigger a maintenance event. By way of example, the real-time vehicle health system 130 may detect a condition which exceeds a vehicle structural health threshold 138, which may trigger a maintenance event to forward to the fleet vehicle structural health system 170 and to ground crews maintaining the aircraft that experienced the event. Another example would be a real-time measurement of the aircraft body from a measurement point near or on the wheel structure, that exceeds the acceleration threshold for a hard landing thereby triggering a maintenance event for ground crews to check the landing gear.

At operation 670 the fleet vehicle structural health system 170 receives the vehicle aeroelasticity flight record 136 from the post-flight vehicle structural health system 150. At operation 675 the controller 172 implements a data smoothing operation which utilizes data from the existing aeroelasticity database 176 for the fleet to which the aircraft 100 belongs and the data received from the post-flight vehicle structural health system 150. The output of data smoothing operation is used to update the fleet aeroelasticity database 176, at operation 680, which may be stored in memory 174.

The fleet aeroelasticity database has the added dimension of time in addition to the three normal structural dimensions of the aircraft body frame. The stochastic data smoothing operation 165 combines from across the fleet like conditions (e.g. instances in which the various aircraft where at various cruise altitudes, speeds, weights significant to the aero design process) into a current estimate of the aircraft structural health. Over time a view of structural health that reveals aircraft structural aging is constructed and the estimator/smoother can predict the future trend and identify outlier vehicles in the fleet for additional structural inspection and monitoring. Vehicle Structural Health Thresholds 138 for the fleet can be constructed and used to initialize the Post Flight VSH System 150 process for new aircraft coming into the fleet.

In subsequent design operations the data collected by the fleet vehicle structural health system 170 may be used in design operations for an aircraft 100. By way of example, the updated and smoothed data from the fleet aeroelasticity database 176 may be used by an aeroelasticity design process 178 to produce updated wing and structural design data 180 for an aircraft 100 in the fleet.

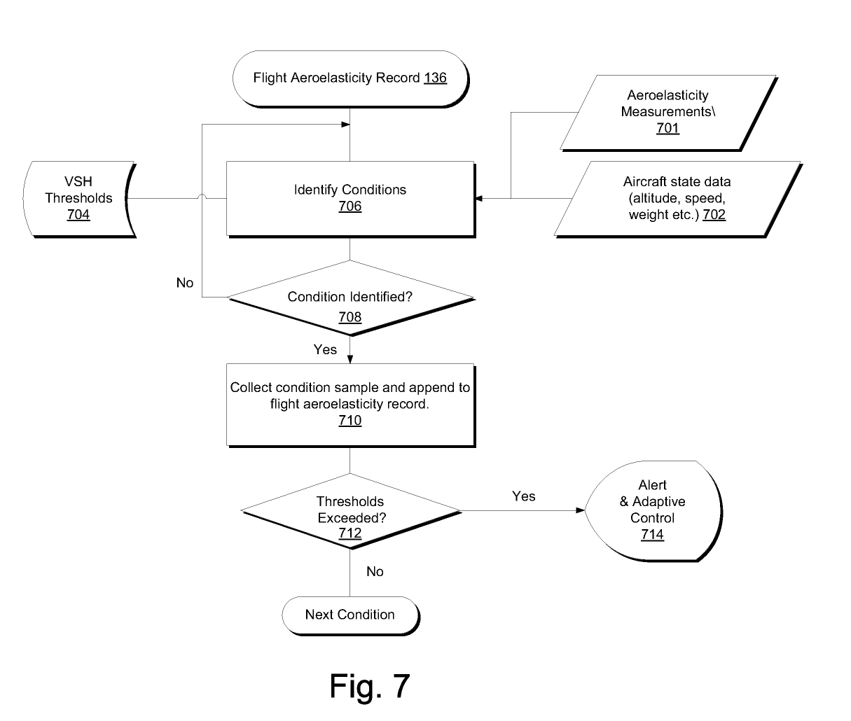

Thus the real time vehicle structural health system 130 of the VSHMS assesses in-flight conditions in real time, identifying one or more conditions which will comprise the flight aeroelasticity record 136 and storing the record 136 for later use in ground based processing system components 150 and 170. FIG. 7 is a flow diagram which describes the creation of the flight aeroelasticity record 136. In some embodiments the operations of FIG. 7 may be stored as logic instructions in a computer readable memory, e.g., the memory module 134, and executed by a processor, e.g., controller 132, during flight operations of aircraft 100.

FIGS. 7-9 provide additional detail on the operations implemented by the three components of the system depicted in FIG. 5. Referring to FIG. 7, aeroelasticity measurements from each IMU 110 of FIG. 5 together with aircraft state data (e.g., altitude, speed, weight, air data etc.) 701 and aircraft state data 702 are examined on the basis of vehicle structural health thresholds 704 that define the conditions to be sought and anomalous event thresholds are used to identify conditions (operation 706) in real time during flight operations. When, at operation 708, a condition is identified, a sample is collected (operation 710) over time and appended to the flight aeroelasticity record 136. By contrast, when a condition is not identified control passes back to operation 706 and additional data is monitored for one or more conditions. If, at operation 712, one or more thresholds are exceeded then control passes to operation 714 and an alert may be generated and data sent to the flight control system for adaptive control of the aircraft.

Referring back to FIG. 5, the post-flight vehicle structural health system 150 of the VSHMS takes a priori design data as a starting point, combines it with flight aeroelasticity record(s) 136 from each new aircraft flight, and implements a stochastic smoothing process that updates the design data into a current model of the aircraft structural characteristics, from which VSH thresholds 138 are extracted. Based on flight aeroelasticity records 136 received and the current structural model, a vehicle aeroelasticity record with time dimension data is formed. In addition, one or more maintenance events may be flagged and thereby trigger aircraft maintenance procedures as a result of the conditions.

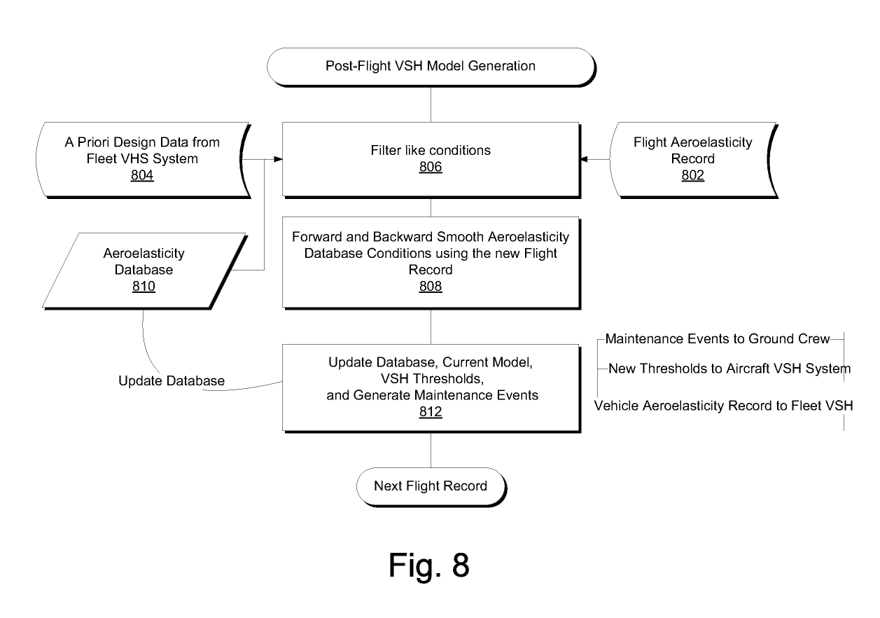

FIG. 8 is a flow diagram illustrating operations in a method to of the vehicle structural health model generation process that is embodied in FIGS. 5 and 6. In some embodiments the operations of FIG. 8 may be stored as logic instructions in a computer readable memory, e.g., the memory module 154, and executed by a processor, e.g., controller 152.

Referring to FIG. 8, a flight aeroelasticity record 802, a priori design data 804, the vehicle aeroelasticity database 810 are used to filter like conditions in the record (e.g., to extract conditions at the same or similar cruise parameters). The condition set is then used 808 to forward and backward smooth the current model of aircraft structural characteristics in the aeroelasticity database. The result is used, at operation 812, to update the database 810, current model of aircraft structural characteristics, VSH thresholds and to generate maintenance events for ground crews. For example a given flight may have a flight aeroelasticity record that indicates a hard landing; a maintenance event to check the landing gear would be generated for the ground crew. Thus the system may be run after each flight to generate and forward this data to the appropriate systems.

The fleet vehicle structural health system 170 receives the vehicle aeroelasticity record from each individual aircraft in the fleet and uses a stochastic estimation and smoothing algorithm to combine these individual records into a fleet aeroelasticity database 176 that also has the dimension of time and therefore provides a view of the structural aging of the fleet. The fleet aeroelasticity database 176 may be used to inform and update the aircraft structural design data for a next generation aircraft, essentially providing the a priori design data for the post flight system 150 in the new generation aircraft.

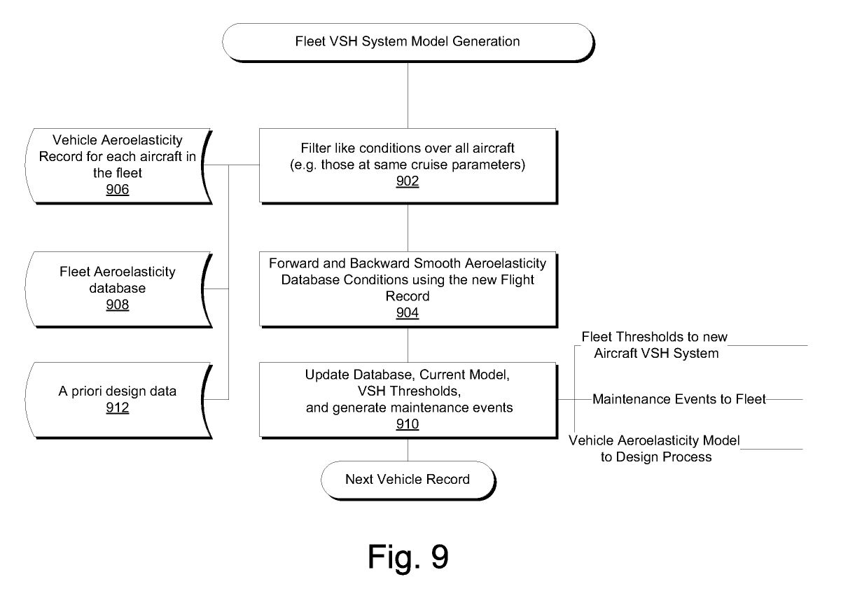

FIG. 9 is a flow diagram illustrating operations in a method to of the vehicle structural health model generation process that is embodied in FIGS. 5 and 6. In some embodiments the operations of FIG. 9 may be stored as logic instructions in a computer readable memory, e.g., the memory module 174, and executed by a processor, e.g., controller 172.

Referring to FIG. 9, vehicle aeroelasticity records 906 from each fleet aircraft, are processed as available, together with the fleet database 908, to filter (operation 902) like conditions over all aircraft. In some embodiments conditions may be considered alike when they arise from the same or similar cruise parameters. Each new set of conditions is then used to forward and backward smooth (operation 904) the current model in the aeroelasticity database 908. These results are then used, at operation 910, to update the database and current model of aircraft structural characteristics, generate fleet maintenance events as required, and create fleet vehicle structural threshold sets to initialize VSH system 150 for a new aircraft. Thus, the database and model inform the next aircraft generation design process. Maintenance events at this stage of the process identify aircraft in the fleet which appear to age more rapidly (e.g., for inspection) and trends in the fleet aging cycle.

Thus, there is described herein an aeroelasticity data collection system for use with an aircraft 100 and a multi-part processing system to generate one or more aeroelasticity flight records which reflect aeroelasticity data collected by the aeroelasticity measurement system over the course of a flight operation, or a portion thereof. The aeroelasticity flight record(s) may be stored in a persistent storage medium, e.g., the memory module 204 of the processing unit 200 onboard the aircraft 100. The aeroelasticity flight record(s) may be provided to a vehicle health monitoring system remote from the aircraft which processes the aeroelasticity flight record(s) to compile an aeroelasticity database for the aircraft. In addition, the vehicle health monitoring system may determine one or more vehicle structural health thresholds from the data in the aeroelasticity database. The structural health thresholds may be returned to the aircraft and subsequently may be used to generate alerts when one or more aeroelasticity measurements exceed a threshold. In addition, aeroelasticity flight record(s) and structural health thresholds may be forwarded to a structural health management system for the fleet of vehicles. The aeroelasticity flight record(s) and structural health thresholds may be used for fleet maintenance and for future design considerations.

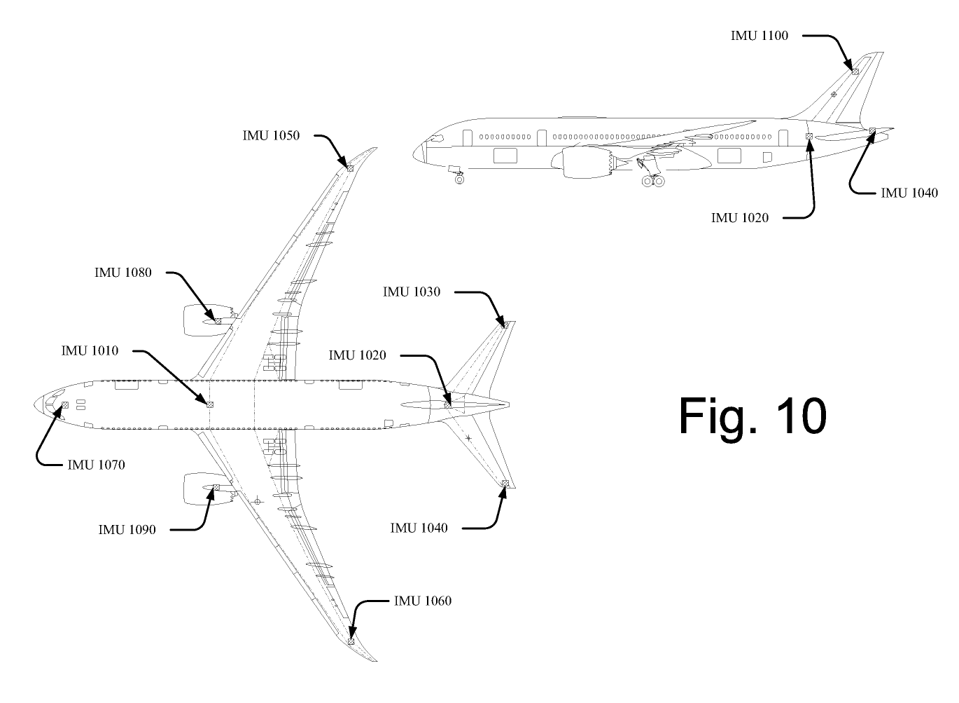

FIG. 10 is a schematic representation of an aircraft having an integrated system for measuring aeroelasticity of the aircraft, according to embodiments. FIG. 10 depicts a system of integrated IMUs 1010-1100 which may be embodied substantially as described with reference to FIG. 1. However, the IMUs 1010-1100 in FIG. 10 are distributed throughout the wing and fuselage of the aircraft 1000. In this embodiment IMU 1010 is a primary reference point for aeroelasticity measurement. Tail IMU 1020 is an alternate reference IMU point with respect to IMUs 1030, 1040 and 1010 that provides an alternate reference for tail fin aeroelasticity. Thus the system monitors the tail region independently. IMU 1020 may be referenced to 1010 as well. IMUs 1080 and 1090 are in the engine struts and 1050 and 1060 are in the wing tip, as these locations represent structural areas of interest for which conditions may be monitored. IMU 1070 is at a nose location to measure body bending and stress at that extreme. One skilled in the art will recognize many embodiments with more (or less) sensors and different locations are possible.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A computer based method to monitor structural integrity of an aircraft, comprising:
receiving, in a processing device aboard the aircraft, a plurality of aeroelasticity measurements and associated flight parameters collected in real time during a flight operation;
storing the plurality of aeroelasticity measurements and associated flight parameters in a memory module; and
generating an alert when one or more aeroelasticity parameters exceeds a threshold.

2. The computer based method of claim 1, wherein the plurality of aeroelasticity measurements and associated flight parameters comprises at least one of:
real-time navigation data associated with the aircraft;
real-time altitude data associated with the aircraft;
real-time weight data associated with the aircraft;
static data such as airplane type, line number, model;
real-time data from a plurality of inertial measurement units on the aircraft.

3. The computer based method of claim 2, further comprising:
preparing an aeroelasticity flight record for the flight operation; and
providing the aeroelasticity flight record to a vehicle health monitoring system remote from the aircraft.

4. The computer based method of claim 3, further comprising:
receiving the aeroelasticity flight record in the vehicle health monitoring system; and
processing the aeroelasticity flight record to compile an aeroelasticity database for the aircraft.

5. The computer based method of claim 4, further comprising:
determining, in the vehicle health monitoring system, one or more vehicle structural health thresholds from the aeroelasticity database; and
returning the one or more vehicle structural health thresholds to the processing device aboard the aircraft.

6. The computer based method of claim 1, wherein determining one or more vehicle structural health thresholds comprises applying a stochastic estimation and smoothing algorithm to the aeroelasticity flight record.

7. The computer based method of claim 4, further comprising providing the aeroelasticity flight record to a fleet aeroelasticity monitoring system remote from the aircraft.

8. The computer based method of claim 7, further comprising:
receiving the aeroelasticity flight record in the fleet aeroelasticity monitoring system; and
integrating the aeroelasticity flight record into a fleet aeroelasticity database.

9. A computer based system to monitor structural integrity of an aircraft, comprising:
a processor;
a memory module coupled to the processor and comprising logic instructions stored on a computer readable medium which, when executed by the processor, configures the processor to:
receive a plurality of aeroelasticity measurements and associated flight parameters collected in real time during a flight operation;
store the plurality of aeroelasticity measurements and associated flight parameters in a persistent storage medium; and
generate an alert when one or more aeroelasticity parameters exceeds a threshold.

10. The computer based system of claim 9, wherein the plurality of aeroelasticity measurements and associated flight parameters comprises at least one of:
real-time navigation data associated with the aircraft;
real-time altitude data associated with the aircraft;
real-time weight data associated with the aircraft;
static data such as airplane type, line number, model;
real-time data from a plurality of inertial measurement units on the aircraft.

11. The computer based system of claim 10, wherein the memory module further comprises logic instructions to:
prepare an aeroelasticity flight record for the flight operation; and
provide the aeroelasticity flight record to a vehicle health monitoring system remote from the aircraft.

12. The computer based system of claim 11, wherein the vehicle health monitoring system remote from the aircraft comprises:
a processor;
a memory module coupled to the processor and comprising logic instructions stored on a computer readable medium which, when executed by the processor, configures the processor to:
receive the aeroelasticity flight record in the vehicle health monitoring system; and
process the aeroelasticity flight record to compile an aeroelasticity database for the aircraft.

13. The computer based system of claim 12, wherein the vehicle health monitoring system remote from the aircraft further comprises logic instructions to:
determine, in the vehicle health monitoring system, one or more vehicle structural health thresholds from the aeroelasticity database; and
return the one or more vehicle structural health thresholds to the processing device aboard the aircraft.

14. The computer based system of claim 13, wherein the vehicle health monitoring system remote from the aircraft further comprises logic instructions to apply a stochastic estimation and smoothing algorithm to the aeroelasticity flight record.

15. The computer based system of claim 13, wherein the vehicle health monitoring system remote from the aircraft further comprises logic instructions to provide the aeroelasticity flight record to a fleet aeroelasticity monitoring system remote from the aircraft.

16. The computer based system of claim 15, wherein the fleet aeroelasticity monitoring system comprises:
a processor; and
a memory module coupled to the processor and comprising logic instructions stored on a computer readable medium which, when executed by the processor, configures the processor to:
receive the aeroelasticity flight record in the fleet aeroelasticity monitoring system; and
integrate the aeroelasticity flight record into a fleet aeroelasticity database.

17. A system to monitor structural health of an aircraft, the system comprising a first computer program product to implement a real-time vehicle structural health monitoring process in an aircraft, the computer program product comprising logic instructions stored on a computer readable medium which, when executed by a processor, configure the processor to:
receive a plurality of aeroelasticity measurements and associated flight parameters collected in real time during a flight operation of the aircraft;
store the plurality of aeroelasticity measurements and associated flight parameters in a persistent storage medium; and
generate an alert when one or more aeroelasticity parameters exceeds a threshold.

18. The system of claim 17, wherein the plurality of aeroelasticity measurements and associated flight parameters comprises at least one of:
real-time navigation data associated with the aircraft;
real-time altitude data associated with the aircraft;
real-time weight data associated with the aircraft; and
real-time data from a plurality of inertial measurement units on the aircraft.

19. The system of claim 17, wherein the first computer program product further comprises logic instructions which, when executed by the processor, configure the processor to:
prepare an aeroelasticity flight record for the flight operation; and
provide the aeroelasticity flight record to a vehicle health monitoring system remote from the aircraft.

20. The system of claim 19, wherein the vehicle health monitoring system remote from the aircraft comprises a second computer program product stored on a computer readable medium which, when executed by a processor, configures the processor to:
receive the aeroelasticity flight record in the vehicle health monitoring system; and
process the aeroelasticity flight record to compile an aeroelasticity database for the aircraft.

21. The system of claim 19, wherein the second computer program product stored on a computer readable medium further comprises logic instructions which, when executed by a processor, configure the processor to:
determine, in the vehicle health monitoring system, one or more vehicle structural health thresholds from the aeroelasticity database; and
return the one or more vehicle structural health thresholds to the processing device aboard the aircraft.

22. The system of claim 20, wherein the second computer program product stored on a computer readable medium further comprises logic instructions which, when executed by a processor, configure the processor to apply a stochastic estimation and smoothing algorithm to the aeroelasticity flight record.

23. The system of claim 22, wherein the second computer program product stored on a computer readable medium further comprises logic instructions to provide the aeroelasticity flight record to a fleet aeroelasticity monitoring system remote from the aircraft.

24. The system of claim 15, wherein the fleet aeroelasticity monitoring system comprises a third computer program product stored on a computer readable medium which, when executed by a processor, configures the processor to:
receive the aeroelasticity flight record in the fleet aeroelasticity monitoring system; and
integrate the aeroelasticity flight record into a fleet aeroelasticity database.
